(19) United States
(12) Patent Application Publication
(10) Pub. No.: US 2005/0076294 A1
(43) Pub. Date: Apr. 7, 2005

(54) Method and apparatus for supporting layout management in a web presentation architecture

(76) Inventors: Brian James DeHamer, San Diego, CA (US); Sankar Ram Sundarosan, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/677,000

(22) Filed: Oct. 1, 2003

(51) Int. Cl. G06F 15/00

(52) U.S. Cl. 715/517

(57) ABSTRACT

A system and method for creating applications, such as web applications, is disclosed. The system comprises a controller generator that is adapted to provide an application with a controller that receives a request for data from a user and responds to the request by sending information to the user in a predetermined format. The system further comprises a layout manager generator that is adapted to provide a layout manager that formats a c-frame based on configuration information and renders the c-frame as part of the information sent to the user in response to the request.

### BACKGROUND OF THE RELATED ART

This is section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

In designing and developing web applications, it may be desirable to allow different groups of individuals to access information using different portals or access points. For example, a company may implement a web application and provide each of its customers with a different web address, each corresponding to a different portal, to allow the customers to access the web application. It may further be desirable to present each group of customers with web pages that feature a customized appearance, which may be referred to as “look and feel,” even though the web pages generated by the web application contain the same content or perform the same service.

A common look and feel when it comes to the presentation and navigation of the pages accessed by a portal may include common graphical, visual or display elements that form the top portion of each page (the “header”), the bottom portion of each page (the “footer”), and the left side bar. These three elements make up what is commonly referred to as the “c-frame” because they frame the content of each page generated by the web application in a set of regions that resembles a block letter “C.”

In existing web presentation architectures, it may be difficult to change the appearance or look and feel of the c-frame for different users or groups of users. Time consuming code changes in the actual content pages may be required to separate page content from the navigational look and feel of the pages.

### BRIEF DESCRIPTION OF THE DRAWINGS

Advantages of one or more disclosed embodiments may become apparent upon reading the following detailed description and upon reference to the drawings in which:

FIG. 1 is a block diagram that illustrates a model-view-controller (“MVC”) application architecture, which may be created using embodiments of the present invention may be employed;

FIG. 2 is a block diagram that illustrates a web presentation architecture in accordance with embodiments of the present invention;

FIG. 3 is a block diagram illustrating a c-frame layout that may be produced by web applications created in accordance with embodiments of the present invention; and

FIG. 4 is a block diagram that illustrates the operation of a web application program created using a web presentation architecture in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

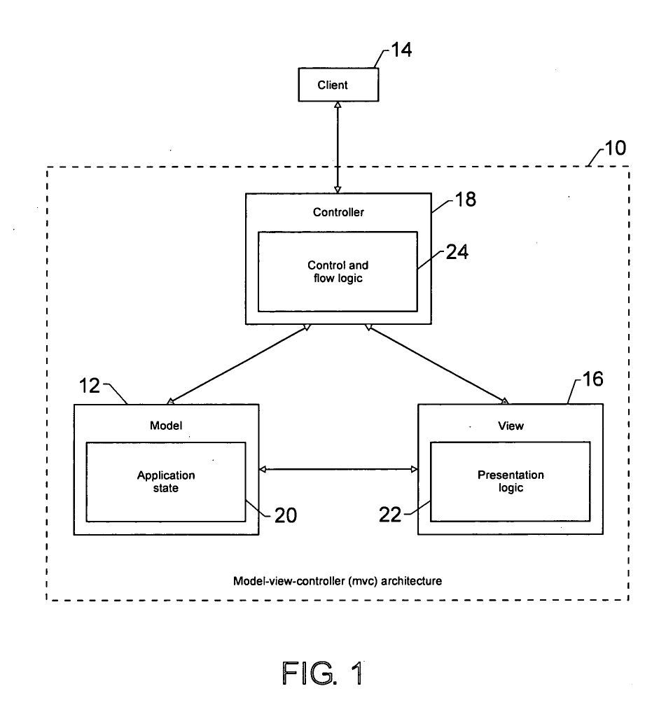

FIG. 1 is a block diagram that illustrates a model-view-controller (“MVC”) application architecture, which may be created using embodiments of the present invention. As illustrated, the MVC architecture 10 separates the application object or model 12 from a view 16, which is responsible for receiving an input and presenting an output to a client 14. In a web application context, the client 14 may comprise a browser. The model object and the view are also separated from the control functions of the application, which are represented in FIG. 1 as a controller 18. In general, the model 12 comprises an application state 20, the view 16 comprises presentation logic 22, and the controller 18 comprises control and flow logic 24. By separating these three MVC objects 12, 16, and 18 with abstract boundaries, the MVC architecture 10 may provide flexibility, organization, performance, efficiency, and reuse of data, presentation styles, and logic.

The WPA 100 may be configured with a variety of object-oriented programming languages, such as Java by Sun Microsystems, Inc., Santa Clara, Calif. An object is generally any item that can be individually selected and manipulated. In object-oriented programming, an object may comprise a self-contained entity having data and procedures to manipulate the data. For example, a Java-based system may utilize a variety of JavaBeans, servlets, Java Server Pages (“JSPs”), and so forth. JavaBeans are independent, reusable software modules. In general, JavaBeans support introspection (a builder tool can analyze how a JavaBean works), customization (developers can customize the appearance and behavior of a JavaBean), events (JavaBeans can communicate), properties (developers can customize and program with JavaBeans), and persistence (customized JavaBeans can be stored and reused). JSPs provide dynamic scripting capabilities that work in tandem with HTML code, separating the page logic from the static elements. According to certain embodiments, the WPA 100 may be designed according to the Java 2 Platform Enterprise Edition (J2EE), which is a platform-independent, Java-centric environment for developing, building and deploying multi-tiered Web-based enterprise applications online.

The model 12 comprises a definitional framework representing the application state 20. For example, in a web-based application, the model 12 may comprise a JavaBean object or other suitable means for representing the application state 20. Regardless of the application or type of object, an exemplary model 12 may comprise specific data and expertise or ability (methods) to get and set the data (by the caller). The model 12 generally focuses on the intrinsic nature of the data and expertise, rather than the extrinsic views and extrinsic actions or business logic to manipulate the data. However, depending on the particular application, the model 12 may or may not contain the business logic along with the application state. For example, a large application having an application tier may place the business logic in the application tier rather than the model objects 12 of the web application, while a small application may simply place the business logic in the model objects 12 of the web application.

As noted above, the view and controller objects 16 and 18 separately address these extrinsic views and actions or business logic. For example, the model 12 may represent data relating to a person (e.g., an address, a birth date, phone number, etc.), yet the model 12 is independent of extrinsic formats (e.g., a date format) for displaying the personal data or extrinsic actions for manipulating the personal data (e.g., changing the address or phone number). Similarly, the model 12 may represent data and expertise to track time (e.g., a clock), yet the model 12 is independent of specific formats for viewing the clock (e.g., analog or digital clock) or specific actions for manipulating the clock (e.g., setting a different time zone). These extrinsic formats and extrinsic actions are simply not relevant to the intrinsic behavior of the model clock object. One slight exception relates to graphical model objects, which inherently represent visually perceptible data. If the model 12 represents a particular graphical object, then the model 12 has expertise to draw itself while remaining independent of extrinsic formats for displaying the graphical object or extrinsic actions for creating or manipulating the graphical object.

The view 16 generally manages the visually perceptible properties and display of data, which may be static or dynamic data derived in whole or in part from one or more model objects 12. As noted above, the presentation logic 22 functions to obtain data from the model 12, format the data for the particular application, and display the formatted data to the client 14. For example, in a web-based application, the view 16 may comprise a Java Server Page (JSP page) or an HTML page having presentation logic 22 to obtain, organize, format, and display static and/or dynamic data. Standard or custom action tags (e.g., jsp:useJavaBean) may function to retrieve data dynamically from one or more model objects 12 and insert model data within the JSP pages. In this manner, the MVC architecture 10 may facilitate multiple different views 16 of the same data and/or different combinations of data stored by one or more model objects 12.

The controller 18 functions as an intermediary between the client 14 and the model object 12 and view 16 of the application. For example, the controller 18 can manage access by the view 16 to the model 12 and, also, manage notifications and changes of data among objects of the view 16 and objects of the model 12. The control and flow logic 24 of the controller 18 also may be subdivided into model-controllers and view-controllers to address and respond to various control issues of the model 12 and the view 16, respectively. Accordingly, the model-controllers manage the models 12 and communicate with view-controllers, while the view-controllers manage the views 16 and communicate with the model-controllers. Subdivided or not, the controllers 18 ensure communication and consistency between the model 12 and view 16 and the client 14.

In operation, the control and flow logic 24 of the controller 18 generally receives requests from the client 14, interprets the client requests, identifies the appropriate logic function or action for the client requests, and delegates responsibility of the logic function or action. Requests may be received from the client via a number of protocols, such as Hyper Text Transfer Protocol (“HTTP”) or HTTP with Secure Sockets Layer (“HTTPS”). Depending on the particular scenario, the appropriate logic function or action of the controller 18 may include direct or indirect interaction with the view 16 and/or one or more model objects 12. For example, if the appropriate action involves alteration of extrinsic properties of data (e.g. reformatting data in the view 16), then the controller 18 may directly interact with the view 16 without the model 12. Alternatively, if the appropriate action involves alteration of intrinsic properties of data (e.g., values of data in the model 12), then the controller 18 may act to update the corresponding data in the model 12 and display the data in the view 16.

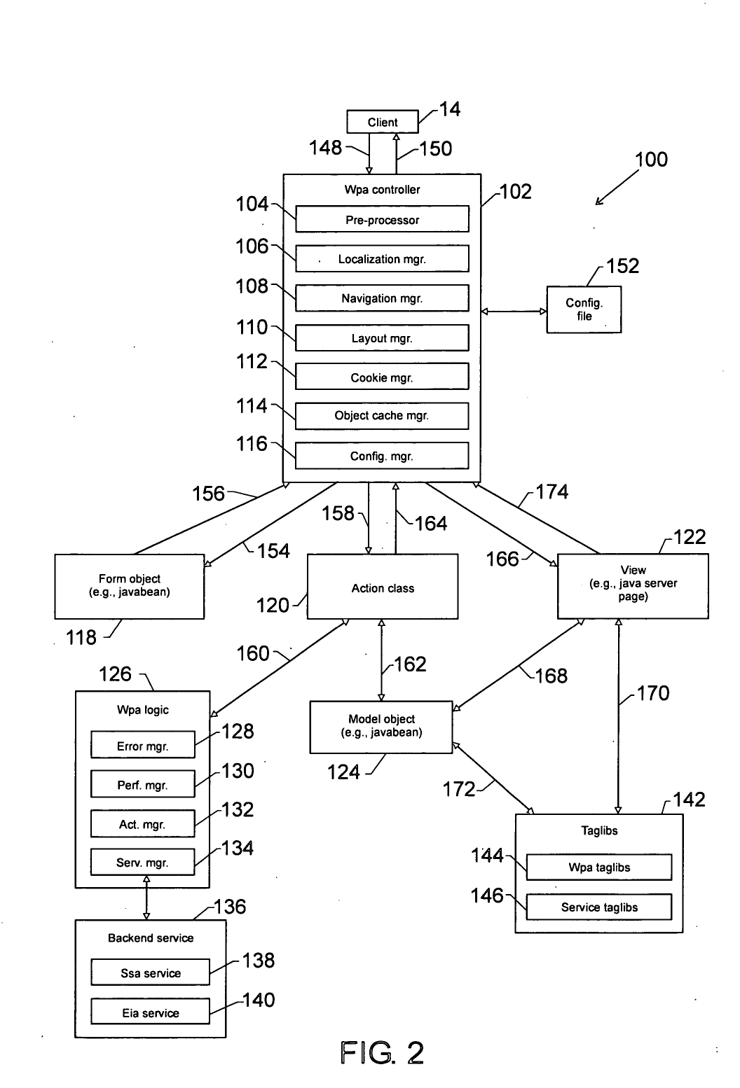

FIG. 2 is a block diagram illustrating an exemplary web presentation architecture (“WPA”) 100 in accordance with certain embodiments of the present invention. The illustrated WPA 100, which may be adapted to execute on a processor-based device such as a computer system or the like, has certain core features of the MVC computing strategy, and various additional features and enhancements to improve its architectural operation and performance. For example, the illustrated WPA 100 separates the model, the view, and the controller as with the traditional MVC architecture, yet the WPA 100 provides additional functionality to promote modularity, flexibility, and efficiency.

As illustrated, the WPA 100 comprises a WPA controller 102 having a preprocessor 104, a localization manager 106, the navigation manager 108, a layout manager 110, a cookie manager 112, and object cache manager 114, and a configuration manager 116. The WPA controller 102 functions as an intermediary between the client 14, form objects 118, action classes 120, and views 122. In turn, the action classes 120 act as intermediaries for creating/manipulating model objects 124 and executing WPA logic 126, such as an error manager 128, a performance manager 130, and activity manager 132, and a backend service manager 134. As described below, the backend service manager 134 functions to interface backend services 136. Once created, the model objects 124 can supply data to the view 122, which can also call various tag libraries 142 such as WPA tag libraries 144 and service tag libraries 146.

In operation, the client 14 sends a request 148 to the WPA 100 for processing and transmission of a suitable response 150 back to the client 14. For example, the request 148 may comprise a data query, data entry, data modification, page navigation, or any other desired transaction. As illustrated, the WPA 100 intakes the request 148 at the WPA controller 102, which is responsible for various control and flow logic among the various model-view-controller divisions of the WPA 100. For example, the WPA controller 102 can be implemented as a Servlet, such as a HyperText Transfer Protocol (“HTTP”) Servlet, which extends the ActionServlet class of Struts (an application framework promulgated by the Jakarta Project of the Apache Software Foundation). As illustrated, the WPA controller 102 invokes a configuration resource file 152, which provides mapping information for form classes, action classes, and other objects. Based on the particular request 148, the WPA controller 102 locates the appropriate action class and, also, the appropriate form class if the request 148 contains form data (e.g., client data input). For example, the WPA controller 102 may lookup a desired WPA Action Form and/or WPA Action Class, which function as interfaces to WPA Form Objects and WPA Action Objects.

If the client entered data, then the WPA controller 102 creates and populates the appropriate form object 118 as indicated by arrow 154. The form object 118 may comprise any suitable data objects type, such as a JavaBean, which functions to store the client entered data transmitted via the request 148. The WPA controller 102 then regains control as indicated by arrow 156.

If the client did not enter data, or upon creation and population of the appropriate form object 118, then the WPA controller 102 invokes the action class 120 to execute various logic suitable to the request 148 as indicated by arrow 158. For example, the action class 120 may call and execute various business logic or WPA logic 126, as indicated by arrow 160 and discussed in further detail below. The action class 120 then creates or interacts with the model object 124 as indicated by arrow 162. The model object 124 may comprise any suitable data object type, such as a JavaBean, which functions to maintain the application state of certain data. One example of the model object 124 is a shopping cart JavaBean, which stores various user data and e-commerce items selected by the client. However, a wide variety of model objects 124 are within the scope of the WPA 100. After executing the desired logic, the action class 120 forwards control back to the WPA controller 102 as indicated by arrow 164, which may be referred to as an “action forward.” This action forward 164 generally involves transmitting the path or location of the server-side page, e.g., the JSP.

As indicated by arrow 166, the WPA controller 12 then invokes the foregoing server-side page as the view 122. Accordingly, the view 122 interprets its links or tags to retrieve data from the model object 124 as indicated by arrow 168. Although a single model object 124 is illustrated, the view 122 may retrieve data from a wide variety of model objects. In addition, the view 122 interprets any special logic links or tags to invoke tag libraries 142 as indicated by arrow 170. For example, the WPA tag libraries 144 and the service tag libraries 146 can include various custom or standard logic tag libraries, such as<html>, <logic>, <template>developed as part of the Apache Jakarta Project or the like. Accordingly, the tag libraries 142 further separate the logic from the content of the view 122, thereby facilitating flexibility and modularity. In certain cases, the tag libraries 142 also may interact with the model object 124 as indicated by arrow 172. For example, a special tag may execute logic to retrieve data from the model object 124 and manipulate the retrieved data for use by the view 122. After interacting with the model object 124 and the appropriate tag libraries 142, the WPA 100 executes the view 122 (e.g., JSP) to create a client-side page for the client 14 as indicated by arrow 174. For example, the client-side page may comprise an extended markup language (“XML”) or HTML formatted page, which the WPA controller 102 returns to the client 14 via the response 150.

As discussed above, the WPA 100 comprises a variety of unique logic and functional components, such as control components 104 through 116 and logic 128 through 134, to enhance the performance of the overall architecture and specific features 100. These components and logic generally operate on the server-side of the WPA 100, yet there are certain performance improvements that may be apparent on the client-side. These various components, while illustrated as subcomponents of the controller 102 or types of logic 126, may be standalone or integrated with various other portions of the WPA 100. Accordingly, the illustrated organization of these components is simply one exemplary embodiment of the WPA 100, while other organizational embodiments are within the scope of the present technique.

Turning to the subcomponents of the WPA controller 102, the preprocessor 104 provides preprocessing of requests by configuring portal specific functions to execute for each incoming request registered to the specific portal. The preprocessor 104 identifies the appropriate portal specific functions according to a preset mapping, e.g., a portal-to-function mapping in the configuration file 152. Upon completion, the preprocessor 104 can redirect to a remote Uniform Resource Identifier (URI), forward to a local URI, or return and continue with the normal processing of the request 148 by the WPA controller 102. One example of such a preprocessing function is a locale, which is generally comprised of language preferences, location, and so forth. The preprocessor 104 can preprocess local logic corresponding to a particular portal, thereby presetting language preferences for subsequent pages in a particular application.

The locale information is also used by the localization manager 106, which functions to render localized versions of entire static pages rather than breaking up the static page into many message strings or keys. Instead of using a single page for all languages and obtaining localized strings from other sources at run time, the localization manager 106 looks up a localized page according to a locale identifier according to a preset mapping, e.g., a locale-to-localized page mapping in the configuration file 152. For example, the capability to render static localized pages in the localization manager 106 is particularly useful for static information, such as voluminous help pages.

The navigation manager 108 generally functions to save a users intended destination and subsequently recall that information to redirect the user back to the intended destination. For example, if the user intends to navigate from point A to point B and point B queries for certain logic at point C (e.g., a user login and password), then the navigation manager 108 saves the address of point B, proceeds to the requested logic at point C, and subsequently redirects the user back to point B.

The layout manager 110 enables a portal to separate the context logic functioning to render the common context from the content logic functioning to render the content portion of the page. The common context (e.g., C-Frame) may include a header, a bottom portion or footer, and a side portion or side bar, which collectively provides the common look and feel and navigational context of the page.

The cookie manager 112 functions to handle multiple cookie requests and to set the cookie value based on the most recent cookie request before committing a response. For example, in scenarios where multiple action classes attempt to set a particular cookie value, the cookie manager 112 caches the various cookie requests and defers setting the cookie value until response time. In this manner, the cookie manager 112 ensures that different action classes do not erase cookie values set by one another and, also, that only one cookie can exist with a particular name, domain, and path.

The object cache manager 114 enables applications to create customized in-memory cache for storing objects having data originating from backend data stores, such as databases or service based frameworks (e.g., Web Services Description Language “WSDL”). The in-memory cache may be customized according to a variety of criteria, such as cache size, cache scope, cache replacement policy, and time to expire cache objects. In operation, the object cache manager 114 improves performance by reducing processing time associated with the data from the backend data stores. Instead of retrieving the data from the backend data stores for each individual request 148, the object cache manager 114 caches the retrieved data for subsequent use in processing later requests.

The configuration manager 116 functions to oversee the loading of frequently used information, such as an error code table, into memory at startup time of a particular web application. The configuration manager 116 may retain this information in memory for the duration of an application server session, thereby improving performance by eliminating the need to load the information each time the server receives a request.

Turning to the WPA logic 126, the error handler or manager 128 functions to track or chain errors occurring in series, catalog error messages based on error codes, and display error messages using an error catalog. The error catalog of the error manager 128 may enable the use of generic error pages, which the error manager 128 populates with the appropriate error message at run time according to the error catalog.

The WPA logic function 126 may comprise performance and activity managers 130 and 132, which may facilitate tracking and logging of information associated with a particular transaction or request. The error manager 128 may also be adapted to participate in tracking and logging operations as well.

The service manager 134 of the WPA logic 126 functions as an interface between the WPA 100 and various backend services 136. In operation, the service manager 134 communicates with the desired backend service 136 according to the client request 148, parses a response from the backend service 136 to obtain the appropriate data, and pass it to the appropriate object of WPA 100.

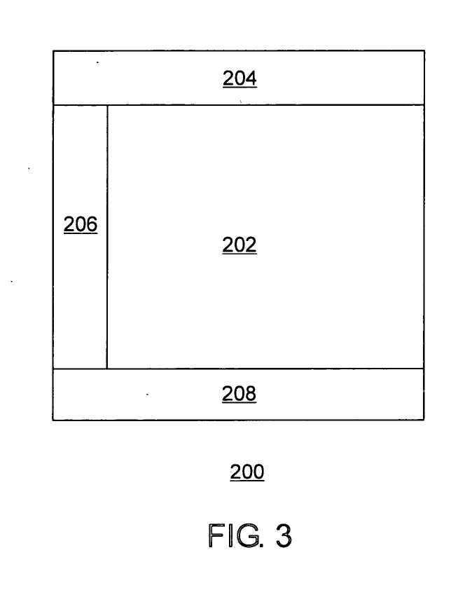

The following discussion relates to the implementation of the layout manager 110, which is an architectural framework that may be used to create layout manager functionality in web applications created therewith. Specifically, the layout manager 110 facilitates the creation of layout manager functionality that incorporates the ability to separate out the code responsible for rendering the c-fame back to a requesting browser from the code that renders the content of the page. This may offer at least two advantages. First, for any specific portal, the work of coding the c-frame may be performed a single time, allowing individual pages to inherit the notion of their c-frame contexts through configuration data, such as configuration files. Second, because the c-frame navigational context is separated from the content of any particular page, it is possible to change the c-frame navigational context of a page by simply changing the configuration information. The configuration files, which may be extended markup language (“XML”) files or the like, may all be loaded upon initialization of the web application. This means that a single content page may be rendered back to a browser using different c-frame navigational contexts as business needs dictate without having to change any of the code responsible for rendering the content itself. An exemplary c-frame is shown and described with reference to FIG. 3.

FIG. 3 is a block diagram illustrating a c-frame layout that may be produced by web applications created in accordance with embodiments of the present invention. The diagram is generally referred to by the reference numeral 200. The diagram 200 corresponds to the layout of a web page that may be generated by a web application. The web page comprises a content area 202. The remaining elements comprise the c-frame, which may provide a standardized look and feel for all content pages that are accessed through a single portal. A header 204, which is disposed along the top edge of the display, may comprise display elements such as a logo, additional text, navigation buttons, locale information and the like. A left side bar 206 may be disposed along the left edge of the display. The left side bar 206 may comprise display elements such as a logo, menu selections, navigation buttons, additional text and the like. A footer 208, which may extend along the bottom of the display, may comprise display elements such as a logo, additional text, navigation buttons, locale information and the like. The header 204, left side bar 206 and footer 208 comprise the c-frame.

In order to create a layout of a c-frame such as the c-frame shown in FIG. 3, a designer of a web application must interact with the layout manager 110 (FIG. 2) to implement the layout, register the layout and map requests for the layout. At runtime, a layout manager created as a portion of a web application, is invoked by the controller and is responsible for decorating the service-specific content with the appropriate layout.

Layouts may be made up of three types of JSP pages: a layout definition page, a template page and component pages. The layout definition page may employ a template such as a “struts-template” tag or the like and may specify which template should be used and which components should be plugged into that template. The following example code may comprise a layout definition:

```
<template:insert template=‘example-template.jsp’>
    <template:put name=‘head’ content=‘head.jsp’ />
    <template:put name=‘top’ content=‘top.jsp’ />
    <template:put name=‘left’ content=‘left.jsp’ />
    <template:put name=‘content’ content=‘<%= contentPage %>’/>
    <template:put name=‘bottom’ content=‘bottom.jsp’ />
</template:insert>
```

The <template:insert> tag specifies the name of the template page and the <template:put> tags identify named components to be included. Note in the example above that the value for the “content” component is assigned dynamically, allowing the use of a single layout definition to render any number of screens. It is the responsibility of the template page to define the overall structure of the page and plug the named components into the appropriate place. The following example code corresponds to a template:

```
<html>
<head>
    <template:get name=‘head’/>
</head>
<body>
    <template:get name=‘top’/>
    <table>
    <tr>
        <td><template:get name=‘left’/></td>
        <td><template:get name=‘content’/></td>
    </tr>
    </table>
    <template:get name=‘bottom’/>
</body>
</html>
```

The <template:get> tags shown in the template above reference the components that were defined in the layout definition page. The layout components that are being inserted into the template above may be normal JSP pages and do not have any special requirements.

Those of ordinary skill in the art will appreciate that embodiments of the present invention may be employed to create, for example, web pages that conform to standard navigational frameworks, while providing similar look and feel for web pages accessed via specific portals. In other words, navigational frameworks that employ the same navigational elements on every page may be created with the same alterable look and feel.

For each layout component, there may be a corresponding model class or group of model classes that allow developers to manipulate certain aspects of the layout at runtime. One model class may be the head model class, which may comprise a head.jsp page. The head.jsp page may render all the elements that need to appear in the <head></head> block at the top of the page. Additionally, a model object will be provided that allows developers to specify a page title, add meta tags, insert a client-side script block or the like.

A file named top.jsp may render standard navigation buttons and the locale information, such as a country indicator or the like at the top of the page. A model object may be provided to specify a country indicator graphic, permanently highlight one of the navigation buttons and/or specify the URLs for each of the five navigation buttons. The head.jsp object and top.jsp object, either alone or together, may comprise the header portion of the c-frame.

Each layout may be provided with configuration information that identifies a left.jsp file that may render visual elements associated with the left side bar element of the layout. As set forth above, these visual elements may be specified in a configuration file, such as an XML file. The left side bar may comprise menu items, sub-menu items, separators or the like. A model object may be provided to allow developers to highlight particular menu items, expand or contract sub-menus, show or hide menu items, add new menu or sub-menus items and/or add content units that will appear under the left navigation menu.

With respect to the footer layout element, a bottom.jsp page may be provided. The bottom.jsp page may render a standard page footer, which may include visual elements such as a copyright notice, links to a privacy statement or legal notices and the like. A model object may be provided to allow developers to specify the URLs for the “privacy statement” and “legal notices” links.

With respect to layout registration, each layout may be registered via a configuration file, such as a layout.xml file. The layout.xml file may comprise a unique name for the layout, the context-relative path to the path to the layout definition page, a fully qualified Java class name of the Action class that should be invoked for a layout (optional) and fully qualified java class names for any model classes that should be loaded for the specific layout. The following example code may correspond to a layout.xml file:

```
<layouts>
    <layout name=“example” path=“/example/jsp/example.jsp”>
        <action class=“com.hp.isso.pl.sample.action.ExampleAction”/>
        <model factoryclass=“com.hp.isso.pl.core.model.HeadFactory”
            name=“pl_model_head”/>
        <model factoryclass=“com.hp.isso.pl.core.model.TopFactory”
            name=“pl_model_top”/>
        <model factoryclass=
          “com.hp.isso.pl.core.model.BottomFactory”
            name=“pl_model_bottom”/>
        <model factoryclass=“com.hp.isso.pl.core.model.LeftFactory”
            config=“/WEB-INF/example-navmenu.xml”
            name=“pl_model_left”/>
    </layout>
</layouts>
```

In the above example code, a layout named “example” is being defined by the layout definition page at “/example/jsp/example.jsp”. This layout has identified an action class named “ExampleAction” that should be invoked for every request that utilizes this layout. Additionally, four model classes have identified that will be created and made available to this layout. In the case of the final <model> tag, a configuration file may also be specified. That configuration file may contain default state information that will be used to initialize the model when it is first created.

With respect to request mapping, every request from a user may be mapped to a layout so that the layout manager renders the correct layout. Requests may be mapped to a specific layout by adding a <set-property> tag to the <action> definition in the associated configuration file. Example code to invoke a particular layout follows:

```
<action-mappings>
    <action
        path=“/sample/content”
        forward=“/sample/jsp/content.jsp”>
        <set-property property=“layout” value=“example”/>
    </action>
</action-mappings>
```

In this example, the registered layout named “example” will be painted around the content.jsp page.

A request/layout mapping may preferably have the following format: <set-property property=“layout” value=“<name of layout>”/>. When the layout manager is invoked by the controller, it may retrieve the layout name from an ActionMapping object. If a layout has been associated with the current request, the layout manager may create a new ActionForward object with the path to the appropriate layout definition page.

There may be instances in which a block of code should be executed for every page that is rendered using a particular layout. Instead of placing this code within each individual page's Action class, an Action class may be registered for the layout. The resulting layout Action may be invoked automatically for every request that is mapped to the layout.

The layout Action class may be an effective place to locate code that updates the c-frame based on the current user state. For example, a “login” item may be hidden in a left side bar navigation menu for a user that is already logged in. The layout Action preferably extends a Struts org.apache.struts.action.Action class and overrides the perform method. The controller may execute the perform method and pass one or more standard parameters.

As previously described with respect to layout registration, a layout action may be registered by adding an <action> element within the <layout></layout> block. For example:

<layout name=“example” path=“/example/jsp/example.jsp”>
<action class=“com.hp.isso.pl.sample.action.ExampleAction”/>
</layout>

The following discussion relates to layout models. Layout components that are completely static may not require a model class. Static elements may be rendered exactly the same way every time they are invoked. However, if certain aspects of the layout change dynamically at runtime, a model class may be created for an application developer to manipulate.

For each of the standard layout components (for example, head, top, left and bottom), there may be a corresponding model class that represents the current state of the component. The model components may be queried at runtime to determine how a particular component should be rendered. For example, the Head class represents the current state of the head.jsp layout component. Developers may call the setPageTitle method to specify the string that should appear in the title bar of a browser that is rendering the layout. When the head.jsp page is being evaluated, the Head class may be queried to determine the string that should be rendered between the <title></title> tags.

There may preferably be a one-to-one mapping between model and layout component. Such a one-to-one mapping may allow the various layout elements to be easily re-used in different layouts. Layout models may be registered in the layout.xml file. The code example below shows part of a layout.xml file that registers a layout named “example” and uses models named Top and Left:

```
<layout name=“example” path=“/example/jsp/example.jsp”>
    <model factoryclass=“com.hp.isso.pl.core.model.TopFactory”
        name=“pl_model_top”/>
    <model factoryclass=“com.hp.isso.pl.core.model.LeftFactory”
        config=“/WEB-INF/example-navmenu.xml”
        name=“pl_model_left”/>
</layout>
```

The factoryclass attribute of the <model> tag may specify the fully qualified Java class name of the factory class that is responsible for creating the model class. This is not the model class itself, but rather a class that may create the desired model class. The factoryclass may preferably implement the LayoutModelFactory interface and override the createModel method specified in that interface. This abstraction allows the layout manager to load the models without having to know their exact identity.

The layout models themselves may preferably implement the LayoutModel interface. This interface is the return type from the createModel method in the LayoutModelFactory interface. The only requirement for the LayoutModel interface is for the subclass to implement the clone method.

The config attribute in the <model> tag may be used to specify a file that contains initial state information for the model. The layout manager may read this file and pass the contents (via an InputStream object) to the createModel method of the factory class. This file may be an XML file or a properties file or the like. The factory class may parse the file contents and initialize the model class appropriately.

The ability to pass configuration information to the model at start-up time allows the re-use of a model in different layouts that may require different initial states. For example, the factory class for the standard Left model may take an XML file that specifies the items to appear in the left navigation bar. An example showing the format of this file is set forth below. Multiple layouts may use the same Left model and simply initialize it with different data.

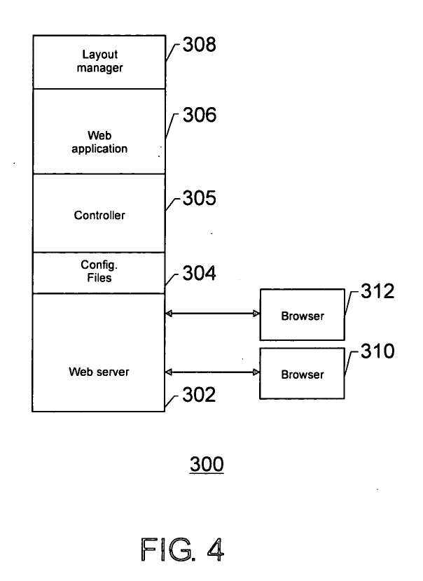

The value of the name attribute in the <model> tag will be used to store the model class in the request scope. For example, a service developer would use the following code to retrieve the Left object defined in the layout.xml file shown above: Left left=(Left)request.getAttribute(“p1_model_left”). The operation of the layout manager functionality created as part of a functioning web application is explained below with reference to FIG. 4.

FIG. 4 is a block diagram that illustrates the operation of a web application program created using a web presentation architecture in accordance with embodiments of the present invention. The diagram is generally referred to by the reference numeral 300.

A web server 302 hosts a web application 306 constructed using a web presentation architecture in accordance with embodiments of the present invention. The web application 306 comprises a controller 305 and a layout manager 308. Those of ordinary skill in the art will appreciate that the controller 305 and the layout manager 308 may be integrated within the web application 306 or may be implemented as separate executable modules. The controller 305 and the layout manager 308 are, respectively, constructed according to the controller architecture 102 (which may function as a controller generator) and the layout manager architecture 110 (which may function as a layout manager generator) illustrated in FIG. 2. Upon initialization or startup, the controller 305 loads configuration information, which may comprise a plurality of configuration files 304, each of which may contain configuration information about a layout that may be employed by the web application when it is accessed by a corresponding portal. The web application 306 may receive requests from users via a first browser 310, which may access the web application 306 using a first portal, and a second browser 312, which may access the web application 306 via a second portal.

The layout manager 308 may be adapted to render different display items corresponding to each of the layouts specified in the configuration files 304. The layout manager 308 may be responsible for making the appropriate LayoutModel objects available to portions of the web application code and rendering the layout back to the browsers 310 and 312. Because the layouts for the two portals are different, each of the browsers 310 and 312 may receive web pages with a different customized feel based on the layout information in their configuration files, even though the rendered pages contain the same content.

The following discussion relates to the process flow of the layout manager 308. When the controller is first started, the configuration files 304 (which may comprise a single layout.xml file) are read. For each layout specified in the configuration files 304, the path to the layout destination file may be saved and an instance of the layout Action class may be created and stored. For each registered model, an instance of the LayoutModelFactory may be created, the model configuration file may be read and a call to createModel may be performed on factory (passing in the contents of the configuration file). The newly created model may then be stored.

When a new request comes into the controller 305, the layout manager 308 may be responsible for determining the current layout by examining the “layout” attribute of the ActionMapping object. For each model registered to the current layout, the model may be cloned and the resulting clone may be stored in request scope. The perform method may be invoked on the layout Action for the current layout. After the service-specific Action class has been called by the controller 305, the layout manager 308 may save the current ActionForward path in request scope and create and return new ActionForward with a path to the appropriate layout definition file.

The following is the document type definition (“DTD”) for an exemplary layout.xml file in which layouts may be registered:

```
<!DOCTYPE layouts [
    <!ELEMENT layouts (layout*)>
    <!ELEMENT layout (action?, model*)>
    <!ELEMENT action EMPTY>
    <!ELEMENT model EMPTY>
    <!ATTLIST layout
        name ID #REQUIRED
        path CDATA #REQUIRED>
    <!ATTLIST action class CDATA #REQUIRED>
    <!ATTLIST model
        factoryclass CDATA #REQUIRED
        name CDATA #REQUIRED
        config CDATA #IMPLIED>
    ]>
```

The following is an example of DTD that may represent an XML file format that may be expected by the LeftFactory class for initializing the left navigation menu model:

```
<!DOCTYPE menu [
    <!ELEMENT menu (menuitem|separator)*>
    <!ELEMENT menuitem (submenu?)>
    <!ELEMENT separator EMPTY>
    <!ELEMENT submenu (menuitem*)>
    <!ATTLIST menu
        title CDATA #IMPLIED
        titlekey CDATA #IMPLIED>
    <!ATTLIST menuitem
        id ID #REQUIRED
        title CDATA #IMPLIED
        titlekey CDATA #IMPLIED
        href CDATA #IMPLIED
        page CDATA #IMPLIED
        style (navArrowReg|navArrowBold) #IMPLIED>
    ]>
```

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system, comprising:
a controller generator that is adapted to provide an application with a controller that receives a request for data from a user and responds to the request by sending information to the user in a predetermined format; and
a layout manager generator that is adapted to provide a layout manager that formats a c-frame based on configuration information and renders the c-frame as part of the information sent to the user in response to the request.

2. The system set forth in claim 1, wherein the controller is adapted to read the configuration information from a configuration file.

3. The system set forth in claim 2, wherein the configuration file is an extensible markup language (“XML”) file.

4. The system set forth in claim 2, wherein the configuration file contains configuration information corresponding to a plurality of portals.

5. The system set forth in claim 4, wherein the layout manager is adapted to produce a different c-frame in response to requests received via each of the plurality of portals.

6. The system set forth in claim 1, wherein the c-frame comprises a header, a left side bar and a footer.

7. The system set forth in claim 6, wherein the header comprises a head.jsp object and a top.jsp object.

8. A method, comprising:
creating, with a processor-based device, a controller that adapted to receive a request for data from a user and respond to the request by sending information to the user in a predetermined format; and
providing a layout manager that formats a c-frame based on configuration information and renders the c-frame as part of the information sent to the user in response to the request.

9. The method set forth in claim 8, comprising adapting the controller to read the configuration information from a configuration file.

10. The method set forth in claim 9, comprising defining the configuration file to be an extensible markup language (“XML”) file.

11. The method set forth in claim 9, comprising defining the configuration file to contain configuration information corresponding to a plurality of portals.

12. The method set forth in claim 11, comprising adapting the layout manager to produce a different c-frame in response to requests received via each of the plurality of portals.

13. The method set forth in claim 8, comprising defining the c-frame to comprise a header, a left side bar and a footer.

14. The method set forth in claim 13, comprising defining the header to comprise a head.jsp object and a top.jsp object.

15. A system, comprising:
means for creating a controller that receives a request for data from a user and responds to the request by sending information to the user in a predetermined format; and
means for creating a layout manager that formats a c-frame based on configuration information and renders the c-frame as part of the information sent to the user in response to the request.

16. The system set forth in claim 15, wherein the controller is adapted to read the configuration information from a configuration file.

17. The system set forth in claim 16, wherein the configuration file is an extensible markup language (“XML”) file.

18. The system set forth in claim 16, wherein the configuration file contains configuration information corresponding to a plurality of portals.

19. The system set forth in claim 18, wherein the layout manager is adapted to produce a different c-frame in response to requests received via each of the plurality of portals.

20. The system set forth in claim 15, wherein the c-frame comprises a header, a left side bar and a footer.

21. The system set forth in claim 20, wherein the header comprises a head.jsp object and a top.jsp object.

22. A program for creating an application, the program comprising:
a machine readable medium;
a controller generator stored on the machine readable medium, the controller generator being adapted to provide an application with a controller that receives a request for data from a user and responds to the request by sending information to the user in a predetermined format; and
a layout manager generator stored on the machine readable medium, the layout manager generator being adapted to provide a layout manager that formats a c-frame based on configuration information and renders the c-frame as part of the information sent to the user in response to the request.

23. The program set forth in claim 22, wherein the controller is adapted to read the configuration information from a configuration file.

24. The program set forth in claim 23, wherein the configuration file is an extensible markup language (“XML”) file.

25. The program set forth in claim 23, wherein the configuration file contains configuration information corresponding to a plurality of portals.

26. The program set forth in claim 25, wherein the layout manager is adapted to produce a different c-frame in response to requests received via each of the plurality of portals.
